(19) United States
(12) Patent Application Publication
(10) Pub. No.: US 2010/0296734 A1
(43) Pub. Date: Nov. 25, 2010

(54) IDENTIFYING AND CLUSTERING BLOBS IN A RASTER IMAGE

(75) Inventor: Joseph Doll, Broomfield, CO (US)

Correspondence Address: Howard H. Sheerin, Attorney at Law, 23233 N. Pima Rd., Suite 113, PMB 174, Scottsdale, AZ, 85255, US

(73) Assignee: COLORCOM, LTD., Broomfield, CO (US)

(21) Appl. No.: 12/469,249

(22) Filed: May 20, 2009

(51) Int. Cl. G06K 9/46

(52) U.S. Cl. 382/192

(57) ABSTRACT

An apparatus is disclosed for processing a raster image comprising a plurality of pixels. The apparatus comprises a computer readable medium for storing steps of a computer program, and a computer processor connected to the computer readable medium for executing the steps of the computer program. A plurality of borders of a first blob in the raster image are identified, and a plurality of borders of a second blob in the raster image are identified. The first blob is compared to the second blob, and when the first blob substantially matches the second blob, a first cluster representing both the first blob and the second blob is generated.

### BACKGROUND

### Description of the Related Art

Image processing generally refers to the manipulation of pictorial data using computers. Computer Aided Design (CAD) is one example of how computers are used to draft complex engineering drawings such as mechanical, architectural or electrical drawings. Other examples of image processing include the manipulation of still photographs or cinema to achieve various effects such as feature enhancement, three-dimensional rendering, or animation. However, the term “image processing” is not limited to pictures—it generally refers to the digitization and computer processing of any analog signal that represents something physical and perceptible in the world. An audio signal can be digitized and processed with computers to perform manipulations such as noise reduction or voice recognition; modulated electrical signals, such as telecommunications or cardiograms, can be digitized and processed by computers to extract pertinent information, and so on. The common factor in image processing is the need to digitize the continuous-time analog signal into a discrete-time digital signal that can be operated on by computers using Boolean mathematics implemented in transistor logic circuits.

A common format for storing and manipulating digitized signals is simply to represent the digital data as a bit-map of pixels, where each pixel represents a particular characteristic (e.g., magnitude or color) of the analog signal. Typically, a picture is digitized into a bit-map of individual pixels where each pixel represents a color of the image in a very small, localized area. When the pixels are displayed as a congregation, the original picture appears without loss of perception to the human eye as long as there is sufficient resolution (number of pixels) both in spatial and color contexts. A black and white picture can be represented with one-bit pixels, where the state of the bit (0 or 1) represents the two colors, black and white. To digitize a picture comprising multiple colors, each pixel is represented using n-bits such that each pixel can take on one of 2n different colors. The process of converting an analog image into a bit-map image is referred to as “rasterizing” the image.

There are several well known problems with raster images that limit or inhibit the full potential of computer manipulation. The amount of memory necessary to store a large photograph having many colors (thousands or even millions of colors) can be immense, and the problem is exacerbated when attempting to digitize a series of photographs such as a scene in a movie. Not only do raster images require large amounts of storage memory, but processing such a large amount of data can be slow, particularly when attempting to transfer raster images over a network such as the internet.

The alternative is to convert the raster image into a mathematical format known as vectors. A vector is a mathematical description of the image which is not constrained by a fixed resolution as with raster data. Furthermore, vectors allow for a much more diverse range of image manipulations due to the mathematical representation of the image. A simple example of a vector is a line beginning at a particular X,Y point in a Cartesian plane and ending at another X,Y point in that plane. To date, however, converting raster images into a series of linear vectors has been largely unsuccessful. This is due to the immense number of different possible patterns that raster images can form. For example, a 3 by 3 pixel matrix of a nine color picture can take on about 21,000 different possible patterns. Each possibility must be accounted for when converting the image into a set of linear vectors. If just one more pixel is added to the matrix, the complexity increases exponentially. Consequently, techniques for converting raster images into linear vectors normally operate on only a small section of the image at a time. The problem with this approach is that the resulting vectorized image appears fragmented due to discontinuities when the individual sections are combined.

### BRIEF DESCRIPTION OF THE DRAWINGS

FIG. 1A shows an apparatus for processing a raster image including a microprocessor connected to a computer readable medium.

FIG. 1B is a flow diagram executed by the microprocessor for identifying borders that define blobs in the raster image, wherein a cluster is generated when blobs match within a threshold.

FIG. 2A shows an example raster image including the letter “e” having a first blob defined by the black outline of the letter, and a second blob defined by the white island of the letter.

FIG. 2B illustrates example borders of the two blobs shown in the letter “e” of FIG. 2A.

FIGS. 3A and 3B show an embodiment wherein a neighborhood of pixels is scanned across the raster image to identify the beginning and ending of the borders within a blob.

FIGS. 4A and 4B illustrate an embodiment wherein a reference point (e.g., a center point) is defined for each blob.

FIG. 5 is a flow diagram according to an embodiment of the present invention wherein two blobs are aligned relative to their reference points before being compared.

FIG. 6A is a flow diagram according to an embodiment of the present invention wherein each blob is compared to other blobs in the raster image, including blobs of existing clusters.

FIG. 6B shows an example raster image wherein the blobs representing the capital letter “E” are represented by a cluster having a number and a position.

FIG. 7A is a flow diagram according to an embodiment of the present invention wherein the blob borders are converted to pixels in order to compare the blobs.

FIG. 7B shows an embodiment of the present invention wherein a distance between the borders of two blobs is accumulated for each pixel.

FIGS. 8A and 8B illustrate an embodiment of the present invention wherein the borders of two blobs are different but match within a threshold and therefore both blobs are associated with a cluster.

FIG. 9A is a flow diagram according to an embodiment of the present invention wherein a super cluster is generated when two sets of clusters match within a threshold.

FIG. 9B shows an example raster image wherein the letters “ee” are represented by a super cluster comprised of the clusters representing each “e”.

### DETAILED DESCRIPTION OF EMBODIMENTS OF THE INVENTION

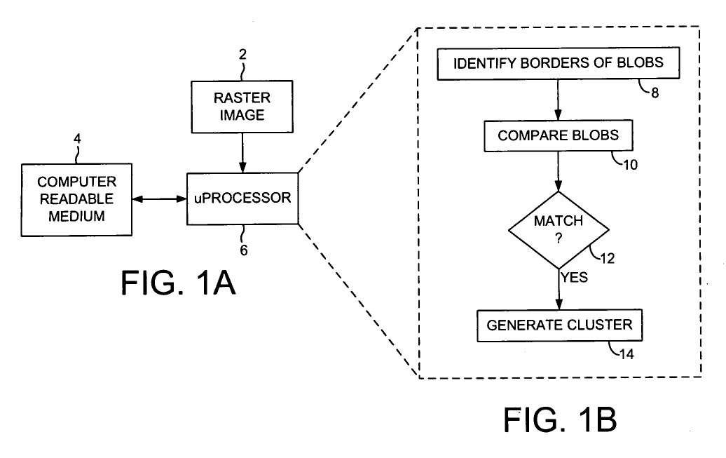

FIG. 1A shows an apparatus for processing a raster image 2 comprising a plurality of pixels. The apparatus comprises a computer readable medium 4 for storing steps of a computer program, and a computer processor 6 connected to the computer readable medium 4 for executing the steps of the computer program. FIG. 1B is a flow diagram illustrating the steps of the computer program according to an embodiment of the present invention. A plurality of borders of a first blob in the raster image are identified, and a plurality of borders of a second blob in the raster image are identified (step 8). The first blob is compared to the second blob (step 10), and when the first blob substantially matches the second blob (step 12), a first cluster representing both the first blob and the second blob is generated (step 14).

The raster image 2 that is processed by the microprocessor 6 can come from many different alternative sources. For example, it may be generated by illuminating a photograph or a sheet of text with a light source and detecting the reflected light with a charge-coupled-device (CCD). A CCD is typically formed of an array of individual photosensitive cells which detect an intensity or brightness of the light. Thus, the output of the CCD is an array of pixels which represent a portion of the raster image bit map. As the light source is scanned over the photograph, the pixels output by the CCD are concatenated to form the entire raster image. Color in the photograph can be detected by employing red-green-blue (RGB) filters in front of three respective CCDs, and then combining the outputs of the CCDs into an n-bit pixel that can represent one of 2ⁿ colors.

The aspects of the present invention are not limited to raster images that represent photographs or pages of text. The present invention can also convert other digitized signals, such as audio or communication signals, for more efficient and effective processing by computers. Such signals are typically generated by a transducer (e.g., a microphone, antenna, recording head, etc.) which senses and transduces into an electrical signal some physical manifestation, such as an acoustic or electromagnetic wave. Typically, the electrical signal is then digitized and converted into a raster format using an analog-to-digital (A/D) converter.

The raster image 2 processed by the present invention can be generated in real time meaning that the raster data can be processed as the analog signal is being digitized. Alternatively, the raster image 2 may be stored on a computer readable medium, such as a magnetic or optical disc, and processed at a later time by the present invention.

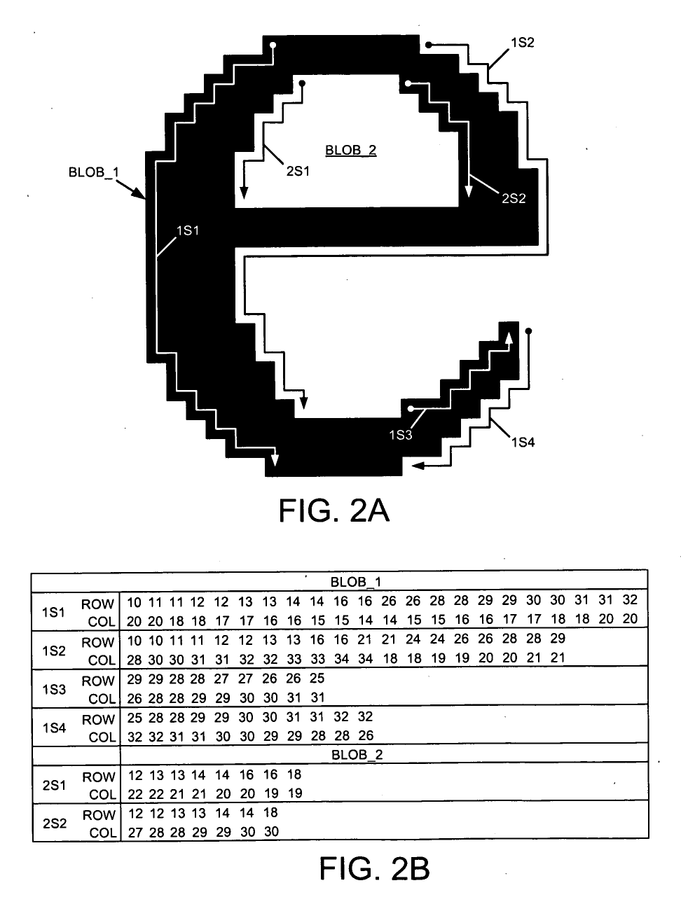

FIG. 2A shows an example raster image including the letter “e” having a first blob defined by the black outline of the letter, and a second blob defined by the white island of the letter. The first blob comprises four borders including two west borders 1S1 and 1S3 and two east borders 1S2 and 1S4. The west borders represent the foreground color along the west edges of the blob, and the east borders represent the background color along the east edges of the blob. The borders of a blob may be represented in any suitable format, an example of which is shown in FIG. 2B wherein each border is represented as a number of segments. Each segment is defined by a beginning pixel location within the raster image, and an ending pixel location within the raster image. For example, the first segment in the west border 1S1 begins at pixel location [10,20] and ends at pixel location [11,20]. Once the borders have been identified, the blob in a raster image may be represented by the borders that define the blob rather than storing each pixel of the raster image. In an embodiment disclosed in greater detail below, when two (or more) blobs in a raster image match within a threshold, a cluster is defined that represents both blobs rather than store the blob twice.

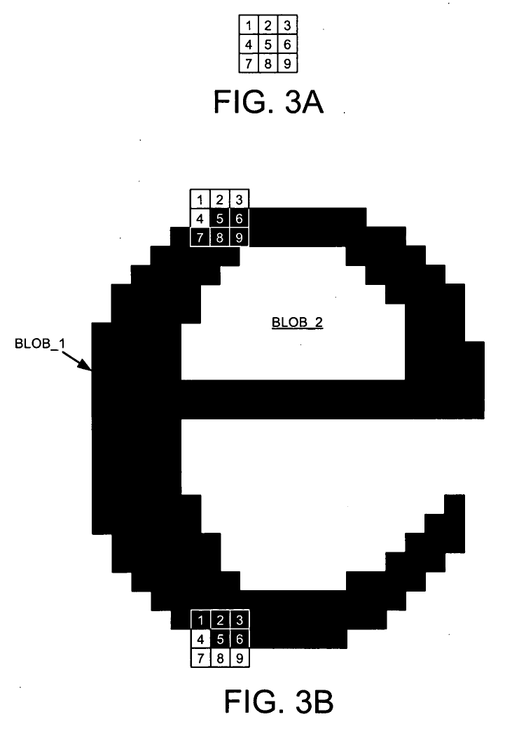

Any suitable technique may be employed to identify the borders of each blob, wherein in an embodiment shown in FIGS. 3A and 3B a neighborhood of pixels (e.g., a 3×3 array) is scanned across the raster image in order to identify the beginning of a border, the segments of the border, and the ending of the border. In the embodiment of FIG. 3B, a border begins whenever the color of pixel 5 is different than the color of pixels 1, 2, 3, 4, and 6. If pixel 6 is the same color as pixel 5, a border begins if none of the subsequent pixels to the right are the same color as pixels 1, 2, and 3. In the example of FIG. 3B, the top of the letter “e” defines the beginning of the west border 1S1. A blob border ends when the color of pixel 5 is different than the color of pixels 4, 6, 7, 8, and 9. If pixel 6 is the same color as pixel 5, a border ends if none of the subsequent pixels to the right are the same color as pixels 7, 8, and 9. Once a west border is defined, a corresponding east border is defined starting from the beginning of the west border. For example, for the west border 1S1 of FIG. 2A, an east border 1S2 begins at the top of the letter “e” and ends at the beginning of west border 1S3. The borders that make up a blob are discovered by tracing the borders until they form a connected shape. In the embodiment of FIG. 2A, the borders of the first blob are discovered by tracing 1S1 to 1S2 to 1S3 to 1S4 to 1S1.

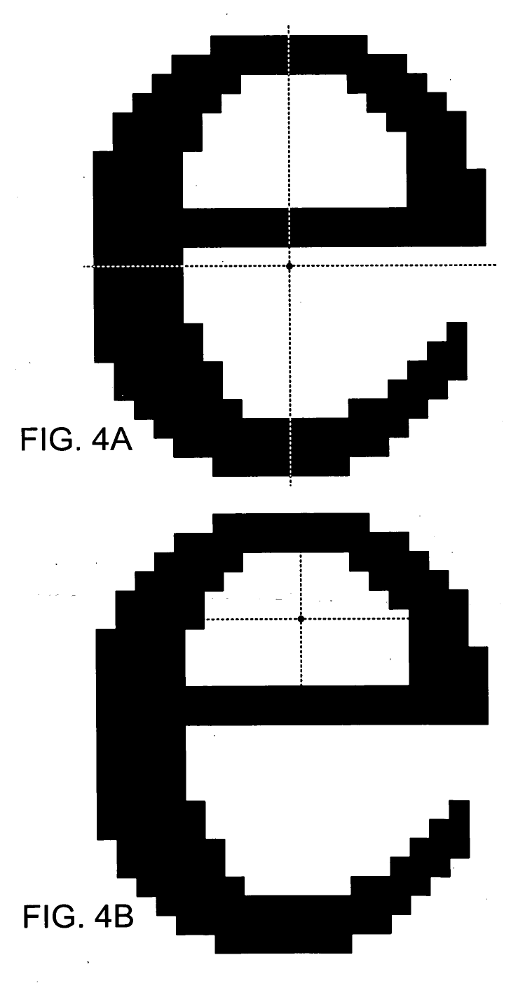

In one embodiment, a reference point is determined for each blob within the raster image. For example, a center point of each blob may be determined as the middle row and column pixel of the blob. FIGS. 4A and 4B show example center reference points for the first and second blob of the example letter “e”. In one embodiment, the reference point is stored with the borders of the blob so that the location of the blob is known when the raster image is reconstructed.

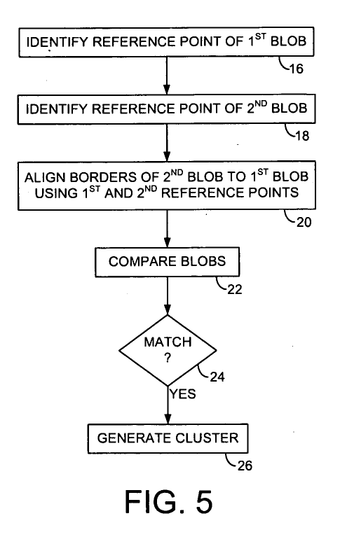

FIG. 5 is a flow diagram according to an embodiment of the present invention wherein a reference point of a first blob is identified (step 16) and a reference point of a second blob is identified (step 18). The reference points are then aligned (step 20) by offsetting the borders of the second blob corresponding to the reference point of the first blob. For example, if the reference point of the first blob is [100,100] and the reference point of the second blob is [400,400], the second blob is aligned with the first blob by subtracting [300,300] from every segment point in each border (e.g., from the segment points shown in FIG. 2B). After aligning the blobs, the blobs are compared by comparing the borders (step 22). If the blobs match within a threshold (step 24), a cluster is generated which represents both blobs rather than store the same blob twice.

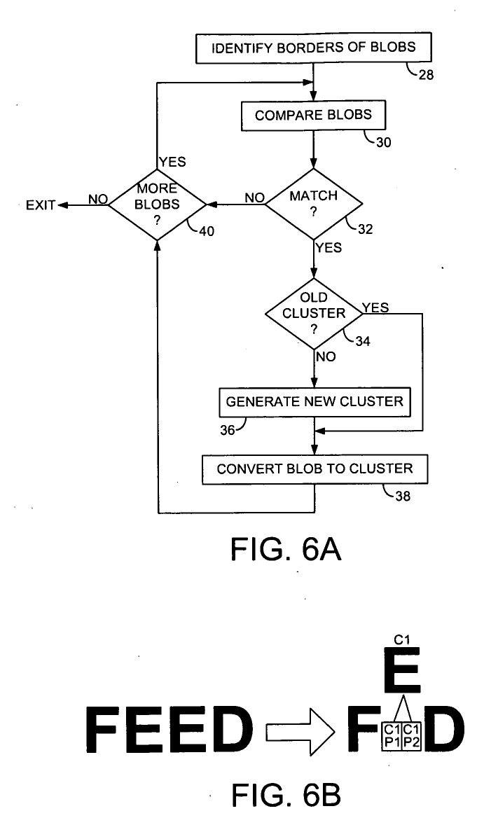

FIG. 6A is a flow diagram according to an embodiment of the present invention wherein the raster image is first processed to identify all the borders of all the blobs in the raster image (step 28). A blob is then selected and compared to other blobs (step 32), including the blobs associated with existing clusters. If there is a match within a threshold (step 32), and the matching blob is already associated with an existing cluster (step 34), then the blob is converted into the cluster (e.g., a number corresponding to the cluster, and a position representing the position of the blob within the raster image). If the matching blob is not already associated with a cluster (step 34), then a new cluster is generated (step 36). In one embodiment, the first blob encountered that establishes a match becomes the reference blob associated with a newly generated cluster. In another embodiment, a number of matching blobs are averaged and the average blob is associated with the cluster. In yet another embodiment, the reference blob for a cluster may be pre-generated, such as by forming perfect blobs representing the letters of the alphabet.

The steps of FIG. 6A are repeated (step 40) for each blob in the raster image, wherein each time a match is found, the blob is converted into a cluster rather than store the blob. In this manner, the matching features of a raster image can be stored in an efficient, noise free (or noise reduced) format. FIG. 6B illustrates this embodiment wherein a raster image comprises the letters “FEED”. The first letter “E” blob matches the second letter “E” blob, and therefore both are stored as cluster C1 having the first letter “E” as the blob associated with the cluster. A position is also stored with each C1 cluster to identify the position within the raster image of the associated blob.

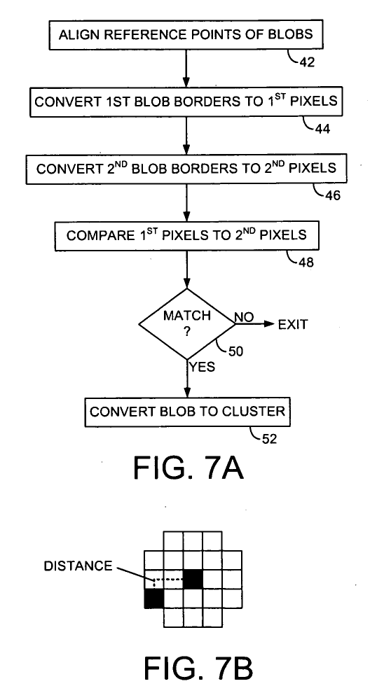

FIG. 7A shows a flow diagram according to an embodiment of the present invention for comparing two blobs by comparing the blob borders. The reference points of the blobs are aligned (step 42), the borders of the first blob are converted into pixels (step 44), and the borders of the second blob are converted into pixels (step 46). The pixels of the first blob borders are compared to the pixels of the second blob borders (step 48) and if there is a match within a threshold (step 50), the blobs are converted into a cluster (step 52).

Any suitable algorithm may be employed to compare the pixels of the blob borders. FIG. 7A shows an embodiment wherein a distance is computed between each pixel in the first blob border and a nearest pixel in a corresponding second blob border. The distance is accumulated for every pixel in the first blob border, and then the accumulated distance (scaled by the total number of pixels in the blob borders) is then compared to a threshold. In one embodiment, only borders of the same type are compared, for example, the west borders of the first blob are compared to the west borders of the second blob, and the east borders of the first blob are compared to the east borders of the second blob.

In another embodiment, the blob borders may be compared by accumulating the number of pixels that match exactly (distance of zero) relative to the total number of pixels in the blob borders. In one embodiment, the reference point of one of the blobs is shifted slightly by an offset (e.g., by one pixel) and the number of matching pixels accumulated for each of a number of different offsets. If any one of the accumulated matching pixels (scaled by the total number of pixels in the blob borders) exceeds a threshold, then the blobs are considered matching.

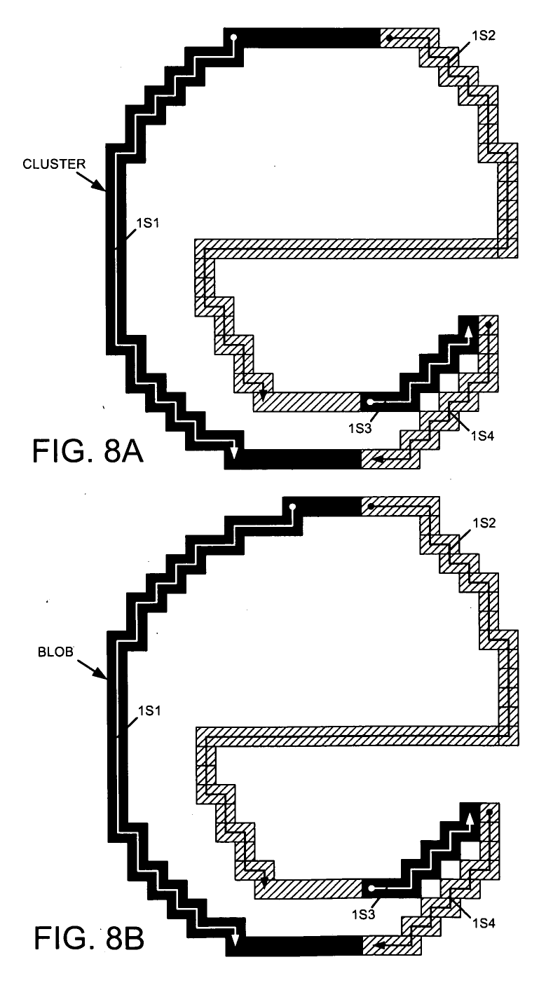

FIG. 8A shows first blob borders associated with a cluster, and FIG. 8B shows second blob borders which are compared to the cluster blob borders. The top segment of the “e” in the blob borders of FIG. 8B is shifted upward by a pixel as compared to the blob borders of FIG. 8A. However, since the accumulated distance between the two sets of blob borders falls below a threshold, the two blobs are considered matching. Therefore the blob of FIG. 8B is converted into the cluster of FIG. 8A such that the blob of FIG. 8B is essentially replaced by the blob of FIG. 8A. This process of replacing blobs in a raster image through clustering may improve data compression, filter noise out of the raster image, and may be used as a form of pattern recognition (e.g., for optical character recognition (OCR)).

In one embodiment, the clusters are grouped and compared to generate super clusters which may further improve data compression and pattern recognition. For example, consider the letter “e” of FIG. 2A wherein the two blobs may also be represented by two clusters. If there are two or more letter “e”s in the raster image, then there associated clusters may match after aligning the reference points of the corresponding blobs and comparing the blob borders as described above. Accordingly, the two clusters representing the blobs of the letter “e” may be converted into a super cluster, and then each letter “e” in the raster image may be converted into the super cluster.

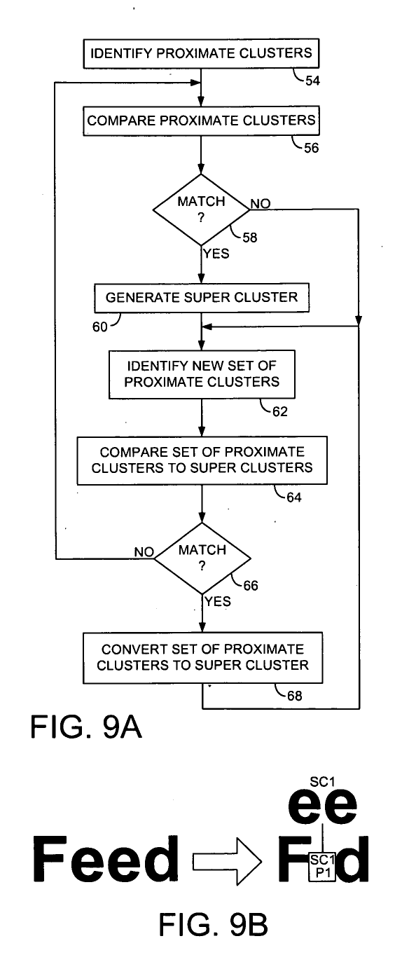

FIG. 9A shows a flow diagram illustrating the super clustering embodiment of the present invention. A first set of proximate clusters is identified (step 54) and then compared to all other sets of proximate clusters (step 56). If a match is found (step 58), a super cluster is generated (step 60), otherwise a new set of proximate clusters is identified (step 62) and compared to all existing super clusters (step 64). If the new set of clusters matches an existing super cluster (step 66), the new set of clusters is converted into the matching super cluster (step 68). If the new set of clusters does not match any of the existing super clusters (step 66), then the new set of clusters is compared to all other sets of proximate clusters (step 56) and a new super cluster is generated (step 60) if a match is found (step 58).

In one embodiment, sets of super clusters may be compared in order to generate yet higher order super clusters. This embodiment is illustrated in FIG. 9B which shows the word “Feed” comprising two consecutive letter “e”s. Each letter “e” may be represented by a super cluster comprising the two blobs shown in FIG. 2A. The super cluster representing the individual “e”s may be combined into a super cluster that represents the combined letters “ee”. Accordingly, every occurrence of the consecutive letters “ee” may be converted into the corresponding super cluster.

The aspect of super clustering can be extended to any number of levels. Consider, for example, an insurance form comprising template text as well as client information entered into each form. The template text may be clustered over multiple levels until each page of template text may be represented by a single super cluster. In this manner, thousands of pages of template forms may be compressed into single clusters representing each page of template text, together with the blobs, clusters, and super clusters representing the individual client information for each page.

The embodiments of the present invention include an apparatus comprising a computer processor for processing a raster image, which may include any suitable device, such as a personal computer receiving a raster image from a suitable peripheral (e.g., an image scanner) or from a computer readable storage medium, or a networked computer receiving a raster image over the Internet, or a consumer electronic device, such as a digital camera or digital video recorder. Another embodiment of the present invention comprises a computer readable medium for storing steps of a computer program for processing a raster image. Any suitable computer readable medium may be employed, such as a magnetic or optical disk, or a solid state memory such as a flash memory. The steps of the computer program may also be stored on the computer readable medium in any suitable form, such as an executable file, or a script file, or source code that can be converted into an executable file.

What is claimed is:

1. An apparatus for processing a raster image comprising a plurality of pixels, the apparatus comprising:
a computer readable medium for storing steps of a computer program; and
a computer processor connected to the computer readable medium for executing the steps of the computer program, wherein the steps of the computer program for:
identifying a plurality of borders of a first blob in the raster image;
identifying a plurality of borders of a second blob in the raster image;
comparing the first blob to the second blob; and
when the first blob substantially matches the second blob, generating a first cluster representing both the first blob and the second blob.

2. The apparatus as recited in claim 1, wherein comparing the first blob to the second blob comprises:
identifying a first reference point in the first blob;
identifying a second reference point in the second blob; and
aligning the first reference point with the second reference point.

3. The apparatus as recited in claim 2, wherein:
the first reference point comprises a center of the first blob; and
the second reference point comprises a center of the second blob.

4. The apparatus as recited in claim 2, wherein comparing the first blob to the second blob comprises:
converting the borders of the first blob into a first plurality of pixels;
converting the borders of the second blob into a second plurality of pixels; and
comparing the first plurality of pixels to the second plurality of pixels.

5. The apparatus as recited in claim 4, wherein comparing the first blob to the second blob comprises computing a distance between a first pixel in a border of the first blob and a second pixel in a border of the second blob.

6. The apparatus as recited in claim 5, wherein comparing the first blob to the second blob comprises accumulating a plurality of the distances.

7. The apparatus as recited in claim 4, wherein:
the first and second blobs comprises a plurality of west and east borders; and
comparing the first blob to the second blob comprises comparing a first pixel in a west border of the first blob to a second pixel in a west border of the second blob.

8. The apparatus as recited in claim 1, wherein the steps of the computer program for:
identifying a plurality of borders of a third blob in the raster image;
comparing the third blob to the first blob; and
when the third blob substantially matches the first blob, converting the third blob into the first cluster.

9. The apparatus as recited in claim 8, wherein the steps of the computer program for:
combining the first cluster and a second cluster into a first super cluster;
compare a third cluster and a fourth cluster to the first super cluster; and
when the third and fourth clusters substantially match the first super cluster, converting the third and fourth clusters into the first super cluster.

10. The apparatus as recited in claim 9, wherein:
the first cluster identifies a first blob having a first reference point;
the second cluster identifies a second blob having a second reference point;
the third cluster identifies a third blob having a third reference point;
the fourth cluster identifies a fourth blob having a fourth reference point; and
comparing the third and fourth clusters to the first super cluster comprises comparing the third and fourth reference points to the first and second reference points.

11. A computer readable medium for storing steps of a computer program, the steps of the computer program for:
identifying a plurality of borders of a first blob in the raster image;
identifying a plurality of borders of a second blob in the raster image;
comparing the first blob to the second blob; and
when the first blob substantially matches the second blob, generating a first cluster representing both the first blob and the second blob.

12. The computer readable medium as recited in claim 11, wherein comparing the first blob to the second blob comprises:
identifying a first reference point in the first blob;
identifying a second reference point in the second blob; and
aligning the first reference point with the second reference point.

13. The computer readable medium as recited in claim 12, wherein:
the first reference point comprises a center of the first blob; and
the second reference point comprises a center of the second blob.

14. The computer readable medium as recited in claim 12, wherein comparing the first blob to the second blob comprises:
converting the borders of the first blob into a first plurality of pixels;
converting the borders of the second blob into a second plurality of pixels; and
comparing the first plurality of pixels to the second plurality of pixels.

15. The computer readable medium as recited in claim 14, wherein comparing the first blob to the second blob comprises computing a distance between a first pixel in a border of the first blob and a second pixel in a border of the second blob.

16. The computer readable medium as recited in claim 15, wherein comparing the first blob to the second blob comprises accumulating a plurality of the distances.

17. The computer readable medium as recited in claim 14, wherein:
the first and second blobs comprises a plurality of west and east borders; and
comparing the first blob to the second blob comprises comparing a first pixel in a west border of the first blob to a second pixel in a west border of the second blob.

18. The computer readable medium as recited in claim 11, wherein the steps of the computer program for:
identifying a plurality of borders of a third blob in the raster image;
comparing the third blob to the first blob; and
when the third blob substantially matches the first blob, converting the third blob into the first cluster.

19. The computer readable medium as recited in claim 18, wherein the steps of the computer program for:
combining the first cluster and a second cluster into a first super cluster;
compare a third cluster and a fourth cluster to the first super cluster; and
when the third and fourth clusters substantially match the first super cluster, converting the third and fourth clusters into the first super cluster.

20. The computer readable medium as recited in claim 19, wherein:
the first cluster identifies a first blob having a first reference point;
the second cluster identifies a second blob having a second reference point;
the third cluster identifies a third blob having a third reference point;
the fourth cluster identifies a fourth blob having a fourth reference point; and
comparing the third and fourth clusters to the first super cluster comprises comparing the third and fourth reference points to the first and second reference points.
